(19) United States
(12) Patent Application Publication
(10) Pub. No.: US 2022/0088905 A1
(43) Pub. Date: Mar. 24, 2022

(54) LAMINATED FILM FOR BONDING AND LIGHT-TRANSMITTING LAMINATE COMPRISING SAME

(71) Applicant: SKC Co., Ltd., Suwon-si (KR)

(72) Inventors: Hyejin KIM, Suwon-si (KR); Haksoo LEE, Suwon-si (KR); Kyuhun KIM, Seoul (KR)

(73) Assignee: SKC Co., Ltd., Suwon-si (KR)

(21) Appl. No.: 17/537,852

(22) Filed: Nov. 30, 2021

Related U.S. Application Data
(63) Continuation of application No. PCT/KR2020/006698, filed on May 22, 2020.

(30) Foreign Application Priority Data
May 31, 2019 (KR) 10-2019-0064646

(51) Int. Cl. B32B 17/10; B32B 7/023

(52) U.S. Cl. CPC B32B 17/10761; B32B 17/10036; B32B 2605/006; B32B 17/10605; B32B 2307/102; B32B 7/023

(57) ABSTRACT

A laminated film for bonding includes: a skin layer comprising a first polyvinyl acetal resin and a first plasticizer; and a core layer comprising a second polyvinyl acetal resin and a second plasticizer, wherein the core layer comprises a metal salt having a refractive index higher than a refractive index of the second plasticizer, wherein a difference between a refractive index of the skin layer and a refractive index of the core layer is 0.0060 or less, and wherein the metal salt is a compound indicated by the following Formula 1:

Mₙ·Xₘ [Formula 1]
in the Formula 1, M is magnesium (Mg), calcium (Ca), sodium (Na), or potassium (K), X is Cl, SO₄, or NO₃, and n and m are integers of 1 or 2, respectively.

### CROSS-REFERENCE TO RELATED APPLICATIONS

Pursuant to 35 USC 120 and 365(c), this application is a continuation of International Application No. PCT/KR2020/006698 filed on May 22, 2020, and claims the benefit under 35 USC 119(a) of Korean Application No. 10-2019-0064646 filed on May 31, 2019, in the Korean Intellectual Property Office, the entire disclosures of which are incorporated herein by reference for all purposes.

### BACKGROUND

### 1. Field

Embodiments are about providing a laminated film having sound insulation performance and improved optical properties, a light-transmitting laminate including the same, and the like, usable as a windshield of a vehicle.

### 2. Related Art

A polyvinyl acetal film is used in laminated glass (safety glass) or an interlayer of a light-transmitting laminate. Laminated glass is mainly used in windows of architecture, cladding, and window glass of automobiles, and due to characteristics, such as anti-scattering of glass fragments when broken and penetration resistance against impact of a certain strength, it can secure stability for minimizing damage or injury given to objects or people disposed in the inside thereof.

Main functions of the laminated glass are preventing penetration through laminated glass (penetration resistance) and absorbing energy caused from impact to minimize damage or injury given to objects or people inside the transparent walls (impact resistance). In addition, the laminated glass should have characteristics (optical properties and moisture resistance properties) such as excellent optical properties to be applicable to clear glass, preventing a double image phenomenon or optical distortion, and robust resistant properties to environmental degradation such as moisture. Besides, an interlayer sheet applied to laminated glass may give an additional functionality to the laminated glass such as reducing sound noise and transmission of UV and/or IR rays. A sound insulating film, which is a film having a functionality of reducing sound noise, is generally formed with three or more layers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a laminated film for bonding includes: a skin layer including a first polyvinyl acetal resin and a first plasticizer; and a core layer including a second polyvinyl acetal resin and a second plasticizer, wherein the core layer includes a metal salt having a refractive index higher than a refractive index of the second plasticizer, wherein a difference between a refractive index of the skin layer and a refractive index of the core layer is 0.0060 or less, and wherein the metal salt may be a compound indicated by the following Formula 1:

Mₙ·Xₘ [Formula 1]

In the Formula 1, M is magnesium (Mg), calcium (Ca), sodium (Na), or potassium (K), X is SO₄, or NO₃, and n and m are integers of 1 or 2, respectively.

The difference between the refractive index of the skin layer and the refractive index of the core layer may be 0.0001 to 0.0060.

A difference between a refractive index of the metal salt and a refractive index of the second plasticizer may be 0.005 or more.

The refractive index of the metal salt may be greater than a refractive index of magnesium acetate and a difference between the refractive index of the metal salt and the refractive index of magnesium acetate may be 0.01 or more.

The metal salt may be CaSO₄.

The core layer may include the compound indicated by the Formula 1 or derivatives of the same.

The metal salt may be included in an amount of 0.01 to 0.5 wt % based on a total weight of the core layer.

The core layer may include SO₄, or NO₃ in an amount of 0.0001 to 0.1 wt % based on a total weight of the core layer.

A difference between an amount of a hydroxyl group in the first polyvinyl acetal resin and an amount of a hydroxyl group in the second polyvinyl acetal resin may be 20 mol % or more.

The laminated film may have a sound insulating functionality and have a loss factor value of 0.34 or more.

The core layer may have a refractive index of 1.477 or more, measured at 532 nm.

The first and the second polyvinyl acetal resin may have a butyral group in an amount of 50 mol % or more, respectively.

The first and the second polyvinyl acetal resin may have a hydroxyl group in an amount of 35 mol % or more, respectively.

The first and the second polyvinyl acetal resin may be a polyvinyl acetal resin obtained by acetalization of a polyvinyl alcohol having a degree of polymerization of 1,600 to 3,000 with aldehyde, respectively.

The first and the second plasticizer may be any one selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibutoxyethoxyethyl adipate (DBEA), butyl carbitol adipate (DBEEA), dibutyl sebacate (DBS), bis 2-hexyl adipate (DHA) and a combination thereof, respectively.

The skin layer may include the first polyvinyl acetal resin in an amount of 60 to 76 wt %.

The skin layer may include the first plasticizer in an amount of 24 to 40 wt %.

The skin layer and the core layer may further include an additive selected from the group consisting of an antioxidant, a heat stabilizer, a UV absorber, a UV stabilizer, an IR absorber, a glass adhesion regulator, and a combination thereof, respectively.

In another general aspect, a laminated film for bonding includes: a first skin layer including a first polyvinyl acetal resin and a first plasticizer; a core layer disposed on the first skin layer and including a second polyvinyl acetal rein and a second plasticizer; and a second skin layer disposed on the core layer and including a third polyvinyl acetal resin and a third plasticizer, wherein the core layer includes a refractive index regulator including a metal salt, wherein a refractive index of the metal salt is higher than a refractive index of the second plasticizer, and wherein the metal salt may be a compound indicated by the following Formula 1:

Mₙ·Xₘ [Formula 1]

In the Formula 1, M is magnesium (Mg), calcium (Ca), sodium (Na), or potassium (K), X is SO₄, or NO₃, and n and m are integers of 1 or 2, respectively.

In still another general aspect, a light-transmitting laminate includes: a first light-transmitting layer; the laminated film for bonding described above and disposed on one surface of the first light-transmitting layer; and a second light-transmitting layer disposed on the laminated film for bonding.

Other features and aspects will be apparent from the following detailed description and the claims.

### BRIEF DESCRIPTION OF THE DRAWINGS

FIG. 1 is a conceptual view for illustrating a structure of the laminated film for bonding according to one embodiment of the present disclosure, by using a cross section thereof.

FIG. 2 is a conceptual view for illustrating a structure of the light-transmitting laminate according to another embodiment of the present disclosure, by using a cross section thereof.

FIG. 3 is a conceptual view for illustrating the vehicle according to another embodiment of the present specification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

In the present disclosure, terms for degree like “about”, “substantially” and so on are used for meaning values approximative from/to the value when a tolerance to be proper to referred meaning for manufacture and substance is presented. Additionally, these terms for degree are used to help understand example embodiments and to prevent the presented content, in which exact or absolute number is referred from being unjustly used by unconscionable trespassers.

Throughout the disclosure, the phrase “combination(s) thereof” included in a Markush-type expression denotes one or more mixtures or combinations selected from the group consisting of components stated in the Markush-type expression, that is, denotes that one or more components selected from the group consisting of the components are included.

Throughout the disclosure, “A and/or B” means “A, B, or A and B”.

Throughout the disclosure, terms such as “first,” “second,” “A,” or “B” are used to distinguish the same terms from each other. The singular forms “a,” “an,” and “the” include the plural form unless the context clearly dictates otherwise.

In the disclosure, “B being disposed on A” means that B is disposed in direct contact with A or disposed over A with another layer or structure interposed therebetween and thus should not be interpreted as being limited to B being disposed in direct contact with A, unless the description clearly dictates.

In the disclosure, a singular form is contextually interpreted as including a plural form as well as a singular form unless specially stated otherwise.

In the disclosure, a size of each component of a drawing can be exaggerated and different from a size to be actually applied.

In the disclosure, the amount of a hydroxyl group was evaluated by measuring an amount of an ethylene group being combined with a hydroxyl group of the polyvinyl acetal resin in accordance with JIS K6728.

For a conventional sound insulating film, a plasticizer in a larger amount is applied to a core layer rather than a skin layer, and such a difference in the amounts of a plasticizer may be a cause of a difference in refractive index between a skin layer and a core layer. Due to the difference in refractive index between two layers, during a film manufacture process, a melt fracture may be easily formed on a surface of a core layer, and this may generate a distortion phenomenon, which can be discerned with the naked eye in the interface between a skin layer and a core layer.

The inventers of the present disclosure have recognized that, if a difference in refractive index between a skin layer and a core layer is reduced by applying a high refractive index additive including a metal salt to the core layer, occurrence of optical defects such as a distortion phenomenon described above can be remarkably reduced, while other properties of the film are maintained, and thus completed the embodiments.

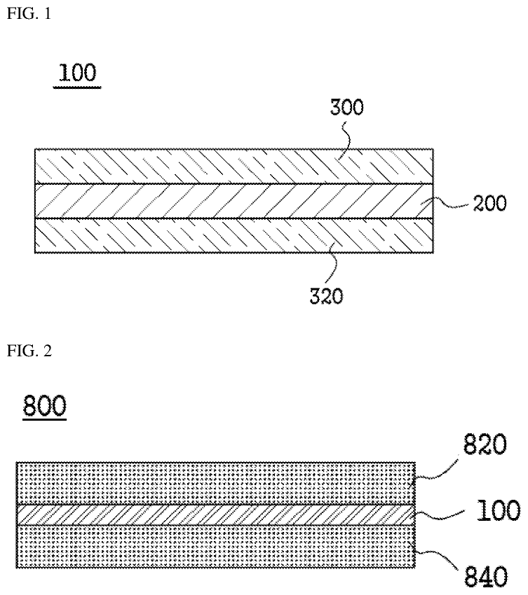

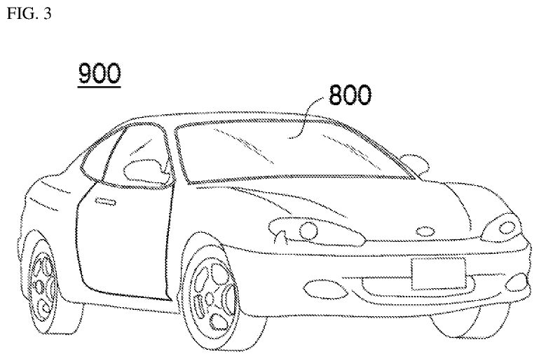

FIG. 1 is a conceptual view for illustrating a structure of the laminated film for bonding according to one embodiment of the present disclosure, by using a cross section thereof. FIG. 2 is a conceptual view for illustrating a structure of the light-transmitting laminate according to another embodiment of the present disclosure, by using a cross section thereof. FIG. 3 is a conceptual view for illustrating the vehicle according to another embodiment of the present disclosure. Hereinafter, respective embodiments disclosed in the present disclosure will be described in further detail with reference to FIGS. 1 to 3.

In a general aspect, the laminated film for bonding 100 according to one embodiment of the disclosure includes a skin layer 300 and a core layer 200, and a refractive index difference between the skin layer and the core layer is 0.0060 or less.

The skin layer 300 includes a first polyvinyl acetal resin and a first plasticizer, and the core layer 200 includes a second polyvinyl acetal resin and a second plasticizer.

A refractive index difference between the skin layer 300 and the core layer 200 is adjusted by applying a high refractive index regulator including a high refractive index metal salt, whose refractive index is higher than the refractive index of the second plasticizer, to the core layer 200.

In detail, the refractive index difference between the skin layer 300 and the core layer 200 may be 0.0060 or less, 0.0020 or less, or 0.0015 or less, or 0.0010 or less. The refractive index difference may be 0 or more, or 0.0001 or more. When having such a difference of refractive index, the difference of refractive index between the skin layer and the core layer becomes inappreciable so that an optical distortion phenomenon caused from such a difference of refractive index does not substantially occur, and particularly even when a melt fracture is formed in the core layer 200 during the film manufacture process, optical defects, which can be observed by the naked eye after being laminated as a light-transmitting laminate 800, may be inappreciable.

The high refractive index metal salt may reduce a refractive index difference between the core layer and the skin layer caused from a difference in the refractive index and the amount between the polyvinyl acetal resin and the plasticizer, and one having a greater refractive index than the plasticizer may be applied.

The high refractive index metal salt may have a refractive index, which is greater by 0.005 or more, 0.010 or more, 0.020 or more, or 2.000 or less, based on the refractive index of the plasticizer. When applying such a high refractive index metal salt to the core layer, it is possible to provide a laminated film with no substantial variation in sound insulation performance and no substantial optical defects. The plasticizer may be based on triethylene glycol bis 2-ethylhexanoate (3G8, refractive index: 1.447) applied in embodiments disclosed in the present disclosure.

The high refractive index metal salt may have a refractive index greater by 0.01 or more, 0.02 or more, 0.04 or more, or 0.07 or more, compared to a refractive index of magnesium acetate (MgAc, refractive index: 1.358). Also, the high refractive index metal salt may have a refractive index difference of 2.00 or less, compared to that of magnesium acetate. When applying a high refractive index metal salt having such a refractive index value, it is possible to obtain an excellent optical defect decreasing effect, while maintaining properties of a laminated film above a certain level.

The high refractive index metal salt may be a compound indicated by following Formula 1. In detail, the high refractive index metal salt may be included in the core layer in a state of a salt (including hydrate) including the above compound, or a state of derivatives of the same.

Mₙ·Xₘ [Formula 1]

In the Formula 1, M is magnesium (Mg), calcium (Ca), sodium (Na), or potassium (K), X is, Cl, SO₄, or NO₃, and n and m are integers of 1 or 2, respectively.

In detail, when M is Mg or Ca, and X is Cl or NO₃, n is 1 and m is 2.

In detail, when M is Mg or Ca, and X is SO₄, n is 1 and m is 1.

In detail, when M is Na or K, and X is Cl or NO₃, n is 1 and m is 1.

In detail, when M is Na or K, and X is SO₄, N is 2 and m is 1.

In further detail, the high refractive index metal salt may be any one selected from the group consisting of MgCl₂, CaCl₂), NaCl, CaSO₄, and a combination thereof.

When applying such a high refractive index metal salt to the core layer 200, it is possible to obtain an excellent optical defect controlling effect, while maintaining a sound insulation characteristic above certain level in a laminated film overall.

The high refractive index metal salt may be included in an amount of 0.01 to 0.5 wt %, or 0.05 to 0.3 wt % based on a total weight of the core layer. When the high refractive index metal salt is included in an amount of less than 0.01 wt % based on the total weight of the core layer, a refractive index controlling effect may be insignificant, and when the high refractive index metal salt is included in an amount of more than 0.5 wt % based on the total weight of the core layer, the refractive index of a core layer may be too high and thereby optical distortion phenomenon may occur.

The high refractive index metal salt may be mixed with a resin or a plasticizer in a state of being dispersed or hydrolyzed in a solvent such as deionized water, and may be detected in the laminated film in a form of metal ions including Cl ion, SO₄ ion, NO₃ ion or derivatives thereof. In detail, the high refractive index metal salt may be detected, converted, and thereby calculated based on the amount of Cl, S, or N in the laminated film. The amount of Cl, S, or N, which is reference of the detection, may be 0.0001 to 0.1 wt % based on the total weight of the core layer.

The amount of Cl, S, or N may be detected by a method of combustion ion chromatography and thereby quantified. For example, a proper amount of a sample (10 to 50 mg) are put into a furnace having an inlet and an outlet through a sample boat, treated with heat at 900° C., and after that, ions generated by burning detection target compounds with Ar/O₂ gas to be absorbed into H₂O₂ solution, are separated by an ion exchange column of Ion Chromatograph to perform qualitative and quantitative analysis through a suppressor-detector. At this time, pressure may be 5.49 MPa, flow may be 1.000 ml/min, and recording time may be 19.0 min.

That is, the core layer 200 may include Cl, SO₄, or NO₃ in an amount of 0.0001 to 0.1 wt % based on the total weight of the core layer.

When applying the high refractive index regulator including the high refractive index metal salt to the core layer 200, it is possible to obtain an effect of reducing optical defects (distortion) that may occur at an interface between skin layer and core layer of the laminated film, by improving fluidity of the core layer during a process of manufacturing the laminated film 100, which is carried out by co-extrusion process, and thereby alleviating a melt fracture, which may occur at a surface of the core layer.

The core layer 200 may have a refractive index of 1.477 or more, measured at 532 nm. The core layer 200 may have a refractive index less than 1.5, measured at 532 nm. A core layer having such a refractive index has a comparatively small refractive index difference with a skin layer and thereby have excellent optical properties so that optical defects such as distortion are not observed with a naked eye in a manufactured laminated glass.

A hydroxyl group amount difference between the first polyvinyl acetal resin and the second polyvinyl acetal resin may be 20 mol % or more, 24 mol % or more, or 26 mol % or more. Also, the hydroxyl group amount difference may be 32 mol % or less. When applying the first polyvinyl acetal resin and the second polyvinyl acetal resin having such a hydroxyl group difference, to a skin layer 300 and a core layer 200, respectively, it is possible to obtain a laminated film, in which a moving phenomenon of a plasticizer does not occur substantially, while having a more excellent sound insulation characteristic and is excellent in moisture resistance and the like.

The polyvinyl acetal resin may have a butyral group in an amount of 50 mol % or more, or 50 to 60 mol %. The first polyvinyl acetal resin may have a hydroxyl group in an amount of 35 mol % or more, 40 mol % or more, or less than 49.5 mol %. When applying a first polyvinyl acetal resin having such a characteristic to the skin layer 300, the skin layer may have proper mechanical properties with being excellently bonded to materials such as glass, and may have an excellent sound insulation characteristic with a core layer.

The first polyvinyl acetal resin may be a polyvinyl acetal resin obtained by acetalization of a polyvinyl alcohol having a degree of polymerization of 1,600 to 3,000 with aldehyde, or may be a polyvinyl acetal resin obtained by acetalization of a polyvinyl alcohol having a degree of polymerization of 1,700 to 2,500 with aldehyde. When such a polyvinyl acetal is applied, mechanical properties like penetration resistance can be sufficiently improved.

The first polyvinyl acetal resin may be one synthesized with polyvinyl alcohol and aldehyde, and the aldehyde is not limited in the type. In detail, the aldehyde may be any one selected from the group consisting of n-butyl aldehyde, isobutyl aldehyde, n-valeraldehyde, 2-ethyl butyl aldehyde, n-hexyl aldehyde, and a mixture thereof. When n-butyl aldehyde is applied as the aldehyde, the resulting polyvinyl acetal resin may have a characteristic of refractive index, whose difference with refractive index of glass is small, and a characteristic in excellent adhesion with glass and the like.

The first plasticizer may be any one selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibutoxyethoxyethyl adipate (DBEA), butyl carbitol adipate (DBEEA), dibutyl sebacate (DBS), bis 2-hexyl adipate (DHA), and a combination thereof. Specifically, first plasticizer may be any one selected from the group consisting of triethylene glycol di-2-ethyl butyrate, triethylene glycol di-2-ethylhexanoate, triethylene glycol di-n-heptanoate, and a combination thereof. More specifically, first plasticizer may be triethylene glycol bis 2-ethylhexanoate (3G8).

The skin layer 300 may include the first polyvinyl acetal resin in an amount of 60 to 76 wt %, 70 to 76 wt %, or 71 to 74 wt % based on a total weight of the skin layer 300. When including the polyvinyl acetal resin in this range, it is possible to give a comparatively excellent mechanical properties to the laminated film 100.

The skin layer 300 may include the first plasticizer in an amount of 24 to 40 wt %, 24 to 30 wt %, or 26 to 29 wt % based on a total weight of the skin layer 300. When the skin layer includes the plasticizer in this range, it is possible to give a proper adhesive strength and impact resistance to the laminated film for bonding 100.

Descriptions on the first polyvinyl acetal resin and the first plasticizer applied to the skin layer 300 may be applied to the third polyvinyl acetal resin and the third plasticizer applied to the second skin layer 320 likewise. In detail, the first polyvinyl acetal resin and the third polyvinyl acetal resin may be the same resin, or another resin having characteristics described above, but it is preferrable that the same resin is applied for efficiency of the manufacture process, if other objectives are not present. In detail, the first plasticizer and the third plasticizer may be plasticizers of same type and in the same amount, or in the different amount from each other, or different types and the amounts from each other.

The second polyvinyl acetal resin applied to the core layer 200 may have a butyral group in an amount of 60 mol % or more, or 60 to 72 mol % based on a total weight of the core layer 200. The second polyvinyl acetal resin may have a hydroxyl group in an amount of 20 mol % or less, 18 mol % or less, or more than 5 mol %. When applying a second polyvinyl acetal resin having such a characteristic to the core layer, the core layer may have excellent optical properties and give excellent sound insulation characteristic to the laminated film.

The second polyvinyl acetal resin may be a polyvinyl acetal resin obtained by acetalization of a polyvinyl alcohol having a degree of polymerization of 1,600 to 3,000 with aldehyde, and may be one synthesized from polyvinyl alcohol and aldehyde. The detailed description regarding the second polyvinyl acetal resin is overlapped with the above description on the first polyvinyl acetal resin and thus further description is omitted.

The detailed description on the type of a plasticizer applicable as the second plasticizer is overlapped with the above description on the first plasticizer and thus further description is omitted.

The core layer 200 may include the second polyvinyl acetal resin in an amount of 58 to 68 wt %, or 63 to 68 wt % based on the total weight of the core layer 200. When including the second polyvinyl acetal resin in this range, it is possible to give mechanical strength in a proper level and simultaneously give a comparatively excellent sound insulation characteristic to the laminated film 100.

The core layer 200 may include the second plasticizer in an amount of 31 to 41 wt %, or 31 to 36 wt % based on the total weight of the core layer 200. When including the plasticizer in this range, it is possible to give proper sound insulation performance and mechanical properties to the laminated film for bonding.

The skin layer 300 and/or core layer 200 may further include an additive described below. The additive may be any one selected from the group consisting of an antioxidant, a heat stabilizer, a UV absorber, a UV stabilizer, an IR absorber, a glass adhesion regulator, and a combination thereof.

As the antioxidant, a hindered amine-based antioxidant or a hindered phenol-based antioxidant may be used. Specifically, on the process of manufacturing polyvinyl butyral (PVB), which needs a processing temperature of 150° C. or higher, a hindered phenol-based antioxidant is further preferable. For example, the hindered phenol-based antioxidant may be IRGANOX 1076, 1010 available from BASF SE, or so on.

As the heat stabilizer, a phosphite-based heat stabilizer may be used, considering suitability with an antioxidant. For example, the heat stabilizer may be IRGAFOS 168 available from BASF SE.

As the UV absorber, Chemisorb 12, Chemisorb 79, Chemisorb 74, or Chemisorb 102 available from CHEMIPRO KASEI KAISHA, LTD may be used, or Tinuvin 328, Tinuvin 329, or Tinuvin 326 available from BASF SE, may be used. As the UV stabilizer, Tinuvin available from BASF SE may be used. As the IR absorber, ITO, ATO, or AZO may be used, and as the glass adhesion regulator applied to the skin layer, a metal salt such as magnesium (Mg), potassium (K), sodium (Na), epoxy-based modified silicon (Si) oil, or a mixture thereof, may be used, but the embodiments are not limited thereto.

The laminated film 100 may include the skin layer 300 and the core layer 200, and may include the core layer 200 disposed between a first skin layer 300 and a second skin layer 320.

The laminated film 100 may be a three-layered structure, or may be a four-layered or five-layered structure further including additive functional layers (ex: head up display, tinted, shade band, IR blocking/reflecting).

The laminated film 100 may further include a buffer layer (not shown) between the skin layer and the core layer, and the buffer layer has functionality of inhibiting moving of the plasticizer in the core layer. And a polyvinyl acetal resin having the same or different properties as above description or a different kind of resin such as TPU (Thermoplastic PolyUrethane) may be applied as the buffer layer.

The laminated film 100 may have a sound insulation functionality, and a loss factor value of 0.34 or more.

The laminated film may have a total thickness of 400 μm or more, or in detail, 400 to 1600 μm, 500 to 1200 μm, or 600 to 900 μm. The laminated film is applied to manufacture of a light-transmitting laminate such as laminated glass. Therefore mechanical strength or sound insulation performance thereof may be enhanced as the thickness is increased. However considering minimal regulation performance, cost and weight reduction, the range of thickness as above is suitable for manufacture of the film satisfying various conditions.

The thickness of the first skin layer and the second skin layer may be 20 to 600 μm, or 200 to 400 μm, respectively.

The thickness of the core layer 200 may be 60 to 600 μm, 70 to 300 μm, or 70 to 200 μm.

A laminated film including respective layers having these thickness ranges can provide a light-transmitting laminate excellent in optical properties and a sound insulation characteristic with having proper mechanical properties.

The laminated film for bonding 100 according to another embodiment disclosed includes a first skin layer 300 including a first polyvinyl acetal resin and a first plasticizer; a core layer 200 disposed on the first skin layer and including a second polyvinyl acetal resin and a second plasticizer; and a second skin layer 320 disposed on the core layer and including a third polyvinyl acetal resin and a third plasticizer. The core layer 200 includes a refractive index regulator including a high refractive index metal salt, and the high refractive index metal salt has a higher refractive index than the refractive index of the second plasticizer.

The amount of Cl, S, or N in the core layer 200 may be 0.0001 to 0.1 wt % based on a total weight of the core layer. For analyzing such an amount, a method of CIC analysis may be applied, the detailed description is overlapped with the above description, and thus further description is omitted.

The type, the amount, characteristics, and the like of the first skin layer 300, the second skin layer 320, and the core layer 200, and the type, the amount, characteristics, and the like of a resin, a plasticizer, an additive, and so on included in these respective layers are overlapped with the above description and thus further description is omitted.

The light-transmitting laminate 800 according to another embodiment disclosed includes a first light-transmitting layer 820; a laminated film 100 for bonding described above and disposed on one surface of the first light-transmitting layer; and a second light-transmitting layer 840 disposed on the laminated film for bonding.

The first light-transmitting layer 820 and the second light-transmitting layer 840 may be a light permeable glass or light permeable plastic, respectively.

The detailed description on the laminated film for bonding 100 is overlapped with the above description and thus further description is omitted.

The light-transmitting laminate 800 may maintain light-transmitting characteristics of the first light-transmitting layer 820 and the second light-transmitting layer 840 as nearly same level, and may have light-transmitting layers in both sides bonded by the laminated film for bonding 100 to have characteristics required to safety glass, such as impact resistance and penetration resistance.

The light-transmitting laminate 800 may satisfy impact resistance characteristics in accordance with KS L 2007:2008.

The light-transmitting laminate 800 may satisfy penetration resistance characteristics in accordance with KS L 2007.

The light-transmitting laminate 800 has excellent functionality when applied as a glass (including a windshield) of automobiles, a cladding of architecture, and the like. Particularly, it is possible to provide a laminated film for bonding 100, whose penetration resistance, a sound insulation characteristic, and an anti-double-image functionality are all satisfied with a comparatively thin thickness when applied as a front glass of automobiles, and the light-transmitting laminate 800 including the same.

The vehicle 900 according to another embodiment disclosed includes the light-transmitting laminate 800 described above, as a windshield.

Any vehicle including a windshield may be applied as the vehicle 900. For example, the vehicle 900 may be an automobile, and the body part, the driving part, the drive wheel, the connector and so on may be included in the vehicle 900 without limit.

The vehicle 900 includes a body part forming a main body of the vehicle 900, a driving part (engine, etc.) attached to the body part, a drive wheel (wheels, etc.) attached to be rotatable to the body part, a connector connecting the drive wheel and the driving part; and a windshield attached to a part of the body part, which is a light-transmitting laminate for blocking wind from outside.

Hereinafter, detailed example embodiments will be described. The below embodiments are just examples to help understanding only, and the scope of the present specification is not limited thereto.

### Preparation Examples

Respective elements used in examples and comparative examples are described as follows.

Preparation of Resins and Additives

A Method of Preparing Polyvinyl Butyral Resin (A):

A polyvinyl alcohol resin having an average polymerization degree of 1700 and a saponification degree of 99 were mixed with n-butyl aldehyde, thereby preparing polyvinyl butyral resin (A) having a butyral group of 56.2 mol % and a hydroxyl group of 42.9 mol %.

A Method of Preparing Polyvinyl Butyral Resin (B):

A polyvinyl alcohol resin having an average polymerization degree of 2400 and a saponification degree of 88 were mixed with n-butyl aldehyde, thereby preparing polyvinyl butyral resin (B) having a butyral group of 68.5 mol % and a hydroxyl group of 16.5 mol %.

Preparation of an Additive for Skin Layers:

Tinuvin-328 as a UV additive of 0.15 parts by weight, H-BHT (dibutyl hydroxy toluene) as an antioxidant of 0.1 parts by weight, and an adhesion regulator of 0.05 parts by weight were mixed, thereby preparing an additive for skin layers of 0.3 parts by weight.

Preparation of Laminated Films for Bonding

A molten resin for skin layers (a resin for skin layers) is prepared by putting polyvinyl butyral resin (A) of 72.2 parts by weight, 3G8 as a plasticizer of 27.5 parts by weight, and an additive for skin layers of 0.3 parts by weight into a twin-screw A for sufficient mulling. A molten resin for core layers is prepared by putting polyvinyl butyral resin (B) of 67 parts by weight, 3G8 as a plasticizer of 32 parts by weight, and an additive for core layers (refer to the composition of core layers in Table 1 below) of 1.0 parts by weight into a twin-screw B for sufficient mulling. The molten resin for skin layers and the molten resin for core layers were co-extruded in a structure of (skin layer)/(core layer)/(skin layer), thereby manufacturing sample films with a total thickness of 780 μm, in which respective layers had a thickness of 330 μm/120 μm/330 μm.

Evaluation of Properties

(1) Optical Defect (Preparation and Evaluation of Samples for Distortion Evaluation)

Prepared sample films were cut into a size of 10 cm×10 cm (length×width) and interposed between two pieces of clear glass (a length of 10 cm, a width of 10 cm, and a thickness of 2.1 cm) to be pre-pressed by performing vacuum lamination for 30 seconds in a laminator at 110° C. and 1 atmospheric pressure. After that, the pre-pressed laminated glass samples were pressed for 20 minutes in an autoclave at a temperature of 140° C. and a pressure condition of 1.2 MPa, thereby obtaining laminated glass samples. The obtained samples were erected with an interval of 10 cm from a wall. Shining LED light on them from the rear of 30 cm with an angle of 20 degrees was performed to check whether optical distortion is observed in shadows on the wall. The results were shown in Table 1 below.

(2) A Method of Measuring Sound Insulation Performance (L/F)

Prepared sample films were cut into a size of 30 cm length, and 2.5 cm width, respectively, and interposed between two pieces of clear glass (a length of 30 cm, a width of 2.5 cm, and a thickness of 2.1 cm) to be pre-pressed by performing vacuum lamination for 30 seconds in a laminator at 110° C. and 1 atmospheric pressure. After that, the pre-pressed laminated glass samples were pressed for 20 minutes in an autoclave at a temperature of 140° C. and a pressure condition of 1.2 MPa thereby obtaining laminated glass samples used for measuring sound insulation performance.

The laminated samples were kept for two weeks in a constant temperature and humidity chamber at 20° C. and 20 RH % (Relative Humidity %) for stabilization, and then sound insulation performance thereof was measured.

Measurement of sound insulation performance was performed as follows.

Vibration was given to the laminated glass samples by a vibration generator for DAMP test, vibration characteristics obtained were amplified by a mechanical impedance measuring device, and vibration spectrum were analyzed by a FFT spectrum analyzer to be calculated by 1 dB method, thereby obtaining L/F (loss factor) values. When the sound insulation performance was 0.34 or more, it was evaluated as Pass, and when the sound insulation performance was less than 0.34, it was evaluated as Fail. The results were listed in Table 1 below.

(3) A Method of Measuring Refractive Index

The refractive indexes of manufactured films were measured by using a prism coupler (model 2010M) available from METRICON CORPORATION (USA) in an off-set mode. All measured values were measured by relative refractive index at 24° C. and a wavelength of 532 nm and shown in Table 1 below.

TABLE 1

| | Refractive Index Regulator | | The Measured Result of | | The Evaluated Result | |
|---|---|---|---|---|---|---|
| | for Core Layer# | | Refractive Index | | of Laminated Glass | |
| | Refractive Index | | Refractive | | | Sound |
| | Regulator | The | Index n of Sound | Refractive | | Insulation |
| | (High Refractive | Amount* | Insulating Layer | Index | | Performance |
| | Index Metal Salt) | (wt %) | (532 nm) | Difference** | DISTORTION | (L/F) |
| Comparative | Potassium | 1 | 1.4771 | 0.007 | FAIL | PASS |
| Example 1 | Acetate | | | | | |
| | (K Ac, Refractive | | | | | |
| | Index: 1.370) | | | | | |
| Comparative | Magnesium | 1 | 1.4769 | 0.0072 | FAIL | PASS |
| Example 2 | Acetate | | | | | |
| | (Mg Ac, | | | | | |
| | Refractive Index: | | | | | |
| | 1.358) | | | | | |
| Example 1 | Calcium Sulfate | | | | | |
| | (Ca SO4, | 1 | 1.4787 | 0.0054 | PASS | PASS |
| | Refractive Index: | | | | | |
| | 1.523) | | | | | |
| Example 2 | Magnesium | | | | | |
| | Chloride (MgCl2, | 1 | 1.4801 | 0.004 | PASS | PASS |
| | Refractive | | | | | |
| | Index:1.675) | | | | | |
| Example 3 | Calcium Chloride | | | | | |
| | (CaCl₂, Refractive | 1 | 1.4786 | 0.0055 | PASS | PASS |
| | Index:1.52) | | | | | |
| Example 4 | Sodium Chloride | 1 | 1.4788 | 0.0053 | PASS | PASS |
| | (NaCl, Refractive | | | | | |
| | Index: 1.5442) | | | | | |

*The amount of a refractive index regulator is an amount when the entire core layer is considered as 100 wt%.
**The Refractive Index Difference = Refractive Index of Skin layer − Refractive Index of Sound Insulating Layer
#The refractive index of the refractive index regulator is a reference value.

Referring to the Table 1, it was verified that distortion occurrences were decreased in Examples 1 to 4 when compared to Comparative Examples applying an acetate salt to a core layer, and sound insulation characteristics were being maintained in the same level or above in Examples.

The laminated film for bonding, the light-transmitting laminate including the same, and the like, of the present disclosure provide a laminated film with sound insulation performance and improved optical properties. The laminated film for bonding can substantially prevent remaining traces such as melt fracture after glass lamination, which may be formed in an extruding process due to methods such as applying a metal salt additive to the core layer, and can substantially prevent optical defects (defect distortion), while maintaining a sufficient sound insulation characteristic

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A laminated film for bonding comprising:
a skin layer comprising a first polyvinyl acetal resin and a first plasticizer; and
a core layer comprising a second polyvinyl acetal resin and a second plasticizer, wherein the core layer comprises a metal salt having a refractive index higher than a refractive index of the second plasticizer,
wherein a difference between a refractive index of the skin layer and a refractive index of the core layer is 0.0060 or less, and wherein the metal salt is a compound indicated by the following Formula 1:
Mₙ·Xₘ [Formula 1]
in the Formula 1, M is magnesium (Mg), calcium (Ca), sodium (Na), or potassium (K), X is SO₄, or NO₃, and n and m are integers of 1 or 2, respectively.

2. The laminated film for bonding of claim 1, wherein the difference between the refractive index of the skin layer and the refractive index of the core layer is 0.0001 to 0.0060.

3. The laminated film for bonding of claim 1, wherein a difference between a refractive index of the metal salt and a refractive index of the second plasticizer is 0.005 or more.

4. The laminated film for bonding of claim 1, wherein the refractive index of the metal salt is be greater than a refractive index of magnesium acetate and a difference between the refractive index of the metal salt and the refractive index of magnesium acetate is 0.01 or more.

5. The laminated film for bonding of claim 1, wherein the metal salt is CaSO₄.

6. The laminated film for bonding of claim 1, wherein the core layer comprises the compound indicated by the Formula 1 or derivatives of the same.

7. The laminated film for bonding of claim 1, wherein the metal salt is comprised in an amount of 0.01 to 0.5 wt % based on a total weight of the core layer.

8. The laminated film for bonding of claim 1, wherein the core layer comprises SO₄, or NO₃ in an amount of 0.0001 to 0.1 wt % based on a total weight of the core layer.

9. The laminated film for bonding of claim 1, wherein a difference between an amount of a hydroxyl group in the first polyvinyl acetal resin and an amount of a hydroxyl group in the second polyvinyl acetal resin is 20 mol % or more.

10. The laminated film for bonding of claim 1, wherein the laminated film has a sound insulating functionality and has a loss factor value of 0.34 or more.

11. The laminated film for bonding of claim 1, wherein the core layer has a refractive index of 1.477 or more, measured at 532 nm.

12. The laminated film for bonding of claim 1, wherein the first and the second polyvinyl acetal resin has a butyral group in an amount of 50 mol % or more, respectively.

13. The laminated film for bonding of claim 1, wherein the first and the second polyvinyl acetal resin has a hydroxyl group in an amount of 35 mol % or more, respectively.

14. The laminated film for bonding of claim 1, wherein the first and the second polyvinyl acetal resin has a polyvinyl acetal resin obtained by acetalization of a polyvinyl alcohol having a degree of polymerization of 1,600 to 3,000 with aldehyde, respectively.

15. The laminated film for bonding of claim 1, wherein the first and the second plasticizer is any one selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibutoxyethoxyethyl adipate (DBEA), butyl carbitol adipate (DBEEA), dibutyl sebacate (DBS), bis 2-hexyl adipate (DHA) and a combination thereof.

16. The laminated film for bonding of claim 1, wherein the skin layer comprises the first polyvinyl acetal resin in an amount of 60 to 76 wt %.

17. The laminated film for bonding of claim 1, wherein the skin layer comprises the first plasticizer in an amount of 24 to 40 wt %.

18. The laminated film for bonding of claim 1, wherein the skin layer and the core layer further comprises an additive selected from the group consisting of an antioxidant, a heat stabilizer, a UV absorber, a UV stabilizer, an IR absorber, a glass adhesion regulator, and a combination thereof, respectively.

19. A laminated film for bonding comprising:
a first skin layer comprising a first polyvinyl acetal resin and a first plasticizer;
a core layer disposed on the first skin layer and comprising a second polyvinyl acetal rein and a second plasticizer; and
a second skin layer disposed on the core layer and comprising a third polyvinyl acetal resin and a third plasticizer,
wherein the core layer comprises a refractive index regulator comprising a metal salt,
wherein a refractive index of the metal salt is higher than a refractive index of the second plasticizer, and
wherein the metal salt is a compound indicated by the following Formula 1:
Mₙ·Xₘ [Formula 1]
in the Formula 1, M is magnesium (Mg), calcium (Ca), sodium (Na), or potassium (K), X is SO₄, or NO₃, and n and m are integers of 1 or 2, respectively.

20. A light-transmitting laminate comprising:
a first light-transmitting layer;
the laminated film for bonding of claim 1 disposed on one surface of the first light-transmitting layer;
and a second light-transmitting layer disposed on the laminated film for bonding.
